(19) United States
(12) Patent Application Publication
(10) Pub. No.: US 2002/0113380 A1
(43) Pub. Date: Aug. 22, 2002

(54) Hybrid superelastic shape memory alloy seal

(76) Inventor: Cary R. Clark, Littleton, CO (US)

Correspondence Address: MCKENNA & CUNEO, LLP, 1900 K Street, NW, Washington, DC, 20006, US

(21) Appl. No.: 09/773,890

(22) Filed: Feb. 2, 2001

(51) Int. Cl. F16J 15/08

(52) U.S. Cl. 277/650

(57) ABSTRACT

A hybrid super-elastomeric seal and method for making same wherein a super-elastic shape memory alloy spring is embedded in an elastomeric material in order to overcome the tendency of the seal to undergo compression set due to time or harsh environment.

The United States Government may have certain rights related to this invention pursuant to Contract No. N00167-99-C-0014 awarded by the Department of the Navy, Naval Surface Warfare Center.

### FIELD OF THE INVENTION

This invention relates generally to an elastomeric seal within which a super-elastic shape memory alloy spring is embedded in order to overcome the tendency of the seal to undergo compression set due to time or harsh environment.

### BACKGROUND OF THE INVENTION

Several U.S. patents relate to the concept of incorporating a coil spring in a seal (see U.S. Pat. Nos. 3,406,979; 3,603,602; 3,813,105 and 5,597,168). Of certain interest is U.S. Pat. No. 3,813,105, which relates to the formation of an O-ring seal of elastomeric material with an embedded helical spring having a lower coefficient of expansion and higher modulus of elasticity than the elastomer. Other references include: U.S. Pat. No. 3,406,979, which relates to a method for molding a coil spring into an elastomeric seal; U.S. Pat. Nos. 4,429,854, 4,537,406 and 5,400,827, which relate to seals and collars that include shape memory alloy rings; and U.S. Pat. No. 4,281,841 which relates to an all metal O-ring made from a shape memory alloy. Importantly, none of these references include a hybrid super-elastomeric seal with a super-elastic shape memory alloy spring embedded within the elastomer, allowing the seal to resist compression set failure due to time or harsh environment.

Accordingly, there exists a need for a seal that possess the ability to resist compression set failure due to time or harsh environment. Such a seal could be used, for example, in preventing fluids such as green water and air-born contaminates from entering a vessel because of inadequate hatch and portal seals. Presently, seal materials used with vessels have a limited life due to environmental degradation and compression set failure, i.e., relaxation. Leakage through such seals occurs after compression set failure and/or degradation due to harsh environments, either of which can cause the sealing capability of the material to decrease over time.

### SUMMARY OF THE INVENTION

The present invention provides the design, production and integration of an optimized super-elastic shape memory alloy core element with a common elastomer to create a novel super-elastomeric seal. In accordance with the present invention, a helical super-elastic shape memory alloy spring is, for example, embedded in or surrounded by an elastomeric material to form a hybrid seal. Thus, the hybrid super-elastomeric seal can be composed of an elastomer and a super-elastic shape memory alloy. An elastomer may be comprised of a natural material, such as rubber, or of a polymer, such as butadiene. In a preferred embodiment of the invention, for example, silicone is the elastomer of choice. Silicone provides a suitable elastomeric medium for use in forming the hybrid super-elastomeric seal of the present invention. Alternatively, different elastomeric materials, such as, for example, fluoro-silicone, rubber, neoprene, nitrile, Viton, and others may be used in the practice of the present invention. In another preferred embodiment of the invention, the super-elastic shape memory alloy is a nickel-titanium alloy that preferably uses stress cycling for reversible martensitic phase transformations. Specifically, the hybrid seal of the present invention may comprise a super-elastic shape memory alloy element in the form of a “spring” embedded in or surrounded by elastomeric material. In a preferred embodiment the “spring” element is, for example, in the form of a helical coil spring. Such a hybrid seal has the ability to resist compression set failure due to time or harsh environment.

A preferred embodiment of the present invention provides seals with reduced compression set failure. Another embodiment of the present invention provides seals with improved recoverable strain capacity for consistently maintaining sealing force. Yet another embodiment of the present invention provides seals with constant seal force after multiple compression sets.

An aspect of the present invention is a seal system comprising the hybrid super-elastomeric seal of the present invention. Another aspect of the present invention provides methods of manufacturing the hybrid super-elastomeric seals of the present invention.

These and other objects and embodiments of the present invention will become apparent to those skilled in the art from the following detailed description, showing the contemplated novel construction, combination, and elements as herein described, and more particularly defined by the appended claims; it being understood that changes in the precise embodiments to the herein disclosed invention are meant to be included as coming within the scope of the claims, except insofar as they may be precluded by the prior art.

### BRIEF DESCRIPTION OF THE DRAWINGS

The accompanying drawings illustrate preferred embodiments of the present invention according to the best modes presently devised for the practical application of the principles thereof.

FIG. 1 is an illustration of a hatch system, shown in cross-section, including the hybrid super-elastomeric seal of the present invention.

FIG. 2 is an enlarged cross-sectional view taken along lines 2-2 of FIG. 1, showing a super-elastic shape memory alloy helical spring element embedded in an elastomeric material, which together comprise one embodiment of the hybrid super-elastomeric seal of the present invention.

FIG. 3 is a graph of stress versus strain showing the tensile stress strain curve for a shape memory alloy helical spring element material as formed, and the tensile stress strain curve of the same material after it has received processing converting it to an optimal super-elastic shape memory alloy helical spring material.

FIG. 4 shows a manufactured super-elastic shape memory alloy ring for use in performing a heat treatment bending test.

FIG. 5 is a graph of bending force versus deflection showing the stress strain curves based on bend tests of several super-elastic shape memory alloy helical ring elements of FIG. 4, each ring having been subjected to a different heat treatment.

FIG. 6 is a graph of bending force vs. deflection showing the stress strain curves based on bend tests of an optimally heat treated super-elastic shape memory alloy helical ring element of FIG. 4 compared with a steel ring of similar geometry.

FIG. 7 shows an exemplary manufacturing process for a super-elastic shape memory alloy helical spring seal.

FIG. 8 is a graph of force versus percent diameter deflection of an optimized hybrid super-elastomeric seal test specimen of the present invention.

FIG. 9 is a graph of percent compression set failure of an optimized hybrid super-elastomeric seal test specimen of the present invention compared with the percent compression set of a similar elastomeric seal that does not contain the embedded super-elastic alloy spring.

FIG. 10 is a graph of percent sealing force over time of an optimized hybrid super-elastomeric seal test specimen of the present invention compared with the percent sealing force of a similar elastomeric seal that does not contain the embedded super-elastic alloy spring.

FIG. 11 is a graph of sealing force over a number of compression set cycles of an optimized hybrid super-elastomeric seal test specimen of the present invention. The seals were subjected to repeating compression sets of 10% to 25% deflection for 10,000 cycles.

FIG. 12 shows the leakage test set up.

FIG. 13 is a graph showing force versus percent diameter deflection for similar sealing forces from two different hybrid super-elastomeric seal geometric configurations of the present invention.

### DETAILED DESCRIPTION OF THE INVENTION

The present invention relates to a hybrid super-elastomeric seal wherein a super-elastic shape memory alloy helical spring is embedded in or surrounded by an elastomeric material. It is understood that the present invention is not limited to the particular methodology, protocols, and reagents, etc., described herein, as these may vary. It is also to be understood that the terminology used herein is used for the purpose of describing particular embodiments only, and is not intended to limit the scope of the present invention. It must be noted that as used herein and in the appended claims, the singular forms “a,”“an,” and “the” include plural reference unless the context clearly dictates otherwise.

Unless defined otherwise, all technical and scientific terms used herein have the same meanings as commonly understood by one of ordinary skill in the art to which this invention belongs. Preferred methods, devices, and materials are described, although any methods and materials similar or equivalent to those described herein can be used in the practice or testing of the present invention. All references cited herein are incorporated by reference herein in their entirety.

### Definitions

Alloy, as described herein, refers to a homogeneous mixture of two or more metals.

Polymer, as described herein, refers to any chemical compound or mixture of compounds formed by polymerization.

Phase transformation, as described herein, refers to a change in the physical properties of a compound, e.g., crystalline structure.

Austenite phase, as described herein, refers to the high temperature or parent phase of an alloy.

Martensite phase, as described herein, refers to the low temperature phase of an alloy Austenite finish temperature, as described herein, refers to the temperature above which the austenite phase of the alloy exists.

Martensite finish temperature, as described herein, refers to the temperature below which the martensite phase of the alloy exists.

Shape memory alloys, as described herein, refers to alloys that exhibit a shape change to the original or ‘memory’ shape of the alloy at a predetermined temperature.

Super-elastic shape memory alloys, as described herein, refers to shape memory alloys that have the ability to recover their shape after relatively large strains.

Compression set, as described herein, refers to the compression of the test specimen to a reduced specimen diameter followed by unloading.

Strain capacity, as described herein, refers to the amount of force a metal or alloy can withstand during compression tests.

Sealing force or seal force, as described herein, refers to the force exerted by the seal required to maintain adequate sealing.

Constant seal force, as described herein, refers to the ability of the hybrid super-elastic shape memory alloy seal to maintain a sealing force that is constant, and preferably showing a zero plus or minus 10% loss in elastomer seal over time and exposure to extreme temperatures. In contrast, elastomer seals of prior art demonstrate 100% force loss, as shown in FIG. 10.

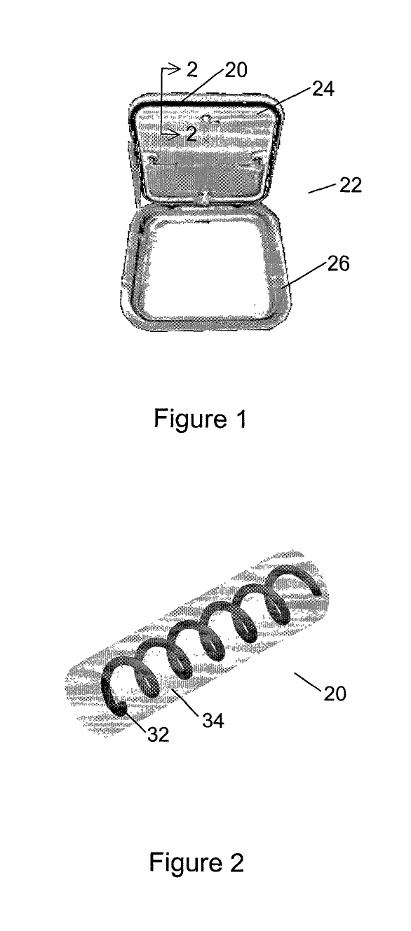

A primary object of the present invention is to provide improvement for sealing applications. Referring to FIG. 1, the hybrid super-elastomeric seals 20 of the present invention have particular utility in seal systems, for example, in sealing hatch systems 22. In this specific embodiment, hatch system 22 comprises a hatch door 24 and a hatch door receiving frame 26. A hybrid super-elastomeric seal 20 is normally carried continuously around the entire circumference of either hatch door 24 or hatch door receiving frame 26, or both, to seal the hatch system 22 to prevent fluids, such as green water, and air-borne contaminants, from entering a vessel, for example, through hatch systems 22 or portals.

In designing hybrid super-elastomeric seals 20, some preferred sealing system requirements were established, including selecting the best materials for hybrid super-elastomeric seal feasibility, designing concept geometry, developing super-elastic shape memory alloy materials for good performance and using finite element modeling analysis with testing to optimize the seal. Referring to FIG. 2, one embodiment of the hybrid super-elastomeric seals 20 of the present invention is shown in cross-section. Hybrid super-elastomeric seals 20 preferably comprises a super-elastic shape memory alloy helical spring element 32 embedded in or surrounded by an elastomeric material 34.

Finite element modeling analysis was used with experiments to optimize seal design. Commercial and military seal requirements, and literature research on sealing problems, were considered in designing the hybrid super-elastomeric seals 20. A general consensus is that compression set failure may be the most common cause of O-ring seal failure. Therefore, one focus of the present invention was to improve or eliminate problems associated with seal compression set failure. Other seal requirements were chosen to avoid environmental problems by simulating and testing the hybrid super-elastomeric seal 20 for shipboard doors or hatches by incorporating the detrimental conditions contributing to their failures. Initial design parameters used were: 1) an O-ring diameter of about 0.5 inch; 2) cross sectional compression of initial diameter by 20 to 25%; 3) life expectancy of 50,000 compression cycles and 15 years exposure time; 4) maximum temperature exposure in excess of 200°C.; and 5) exposure to harsh environment, including weather, water, ozone, oxidation and radiation.

The present invention teaches hybrid seals in the form of an elastomeric material in which a super-elastic shape memory alloy spring is embedded (i.e., surrounded), for example, during molding. Such a hybrid seal preferably has the ability to resist compression set failure due to time or harsh environment. The hybrid super-elastomeric seals 20 of the present invention required the design of the geometric configurations for the super-elastic shape memory alloy element 32, and the integration of the super-elastic shape memory alloy element 32 into the elastomeric material 34 in order to provide the mechanical backbone of the seal 20. Common shape memory alloys revert to their original or ‘memory’ shape at a predetermined temperature. This shape recovering phenomenon occurs through a material phase transformation between austenite and martensite phases. By thermal cycling the material, a phase transformation between the high temperature austenite phase and the low temperature martensite phase of the alloy occurs. Super-elastic shape memory alloys are produced from shape memory alloys. These alloys differ from common shape memory alloys, and other metals and alloys, in that they have the ability to recover their shape after relatively large strains under adverse conditions. Super-elastic shape memory alloy spring elements 32 preferably have a transformation temperature below the temperature to be used in the application. Thus, these materials are in the austenite phase at application temperature. These alloys produce the super-elastic effect when stress is applied to the shape memory alloy in the austenite phase, which stress-induces the martensite phase. The super-elastic shape memory alloy therefore uses stress cycling, as opposed to thermal cycling, for its reversible martensitic phase transformation. In the present invention, nickel-titanium alloy is a preferred super-elastic shape memory alloy. Nickel-titanium alloy was chosen for its availability, good performance characteristics, and the availability of data on the material properties and mechanical behavior of its alloys.

More specifically, a preferred embodiment of the seals 20 of the present invention comprises a super-elastic shape memory alloy element 32 in the form of a spring embedded in an elastomeric material 34, as shown in FIG. 2. In this preferred embodiment, the spring element is in the form of a helical coil with relatively large strokes. The spring exerts nearly constant force thereby providing an internal actuation mechanism compensating for any viscoelastic creep in the elastomeric material 34 of seal 20. Depending on the configuration of element 32, the super-elastic shape memory alloy is loaded in tension, compression, torsion or a combination of these forces, such as bending. Thus, the helical super-elastic shape memory alloy spring 32 may be in any form that provides tensility, compression, torsion or bending, such as helical form or in the form of a c-section. In a specific embodiment, the helical super-elastic shape memory alloy spring 32 may be formed from super-elastic shape memory alloy wire, ribbon, sheet, rod, or other forms of the alloy. The super-elastic shape memory alloy helical spring 32 provides seals 20 with compression strength and elastomer 34 provides seals 20 with surface conformance required for sealing. This configuration of the spring 32 primarily applies a bending load to the super-elastic shape memory alloy element thereby applying a constant sealing force to seals 20. The spring element may also be found in other geometric configurations, including leaf or tubular forms.

In another preferred embodiment, elastomeric material 34 is a polymeric material that is compressible and tends to resume its original size and shape, unless it has experienced compression set failure. An elastomer may comprise a natural material, such as rubber, or a polymer, such as butadiene. In the present invention, silicone is a preferred elastomer. Silicone has good sealing characteristics, is available as a castable material, is available in different durometers, and is known to experience compression set failure when used to form a seal. Furthermore, silicone is presently used for navy shipboard door seals. Therefore, silicone is a good representative of existing seal technology, and provides a good elastomeric medium for use in forming the hybrid super-elastomeric seal of one embodiment of the present invention. Alternatively, different elastomeric materials such as fluoro-silicone, rubber, neoprene, nitrile, Viton, and others may be used as the elastomer of the present invention.

The hybrid super-elastomeric seals 20 of the invention may be design optimized for different applications. Design optimization may be facilitated by the development of engineering tools, as detailed below. The tests were designed to facilitate better understanding of the complex interactions of the variables involved in the hybrid super-elastomeric seal systems of the present invention. These experiments were used to determine the interaction of the super-elastic shape memory alloy spring element 32 and elastomer 34 hybrid components, in order to optimize the final hybrid super-elastomeric seal 20. That is, in order to optimize the performance of the hybrid seals 20, the mechanical characteristics of the super-elastic shape memory alloy spring element 32 were maximized for the complex force interactions with the elastomer. An optimized elastomer was used in order to better survive both harsh environments and wear. The design separated hybrid super-elastomeric seals 20 force requirements from the sealing function of elastomeric material 34. Preferred geometries of the seal can be in O-ring or gasket form.

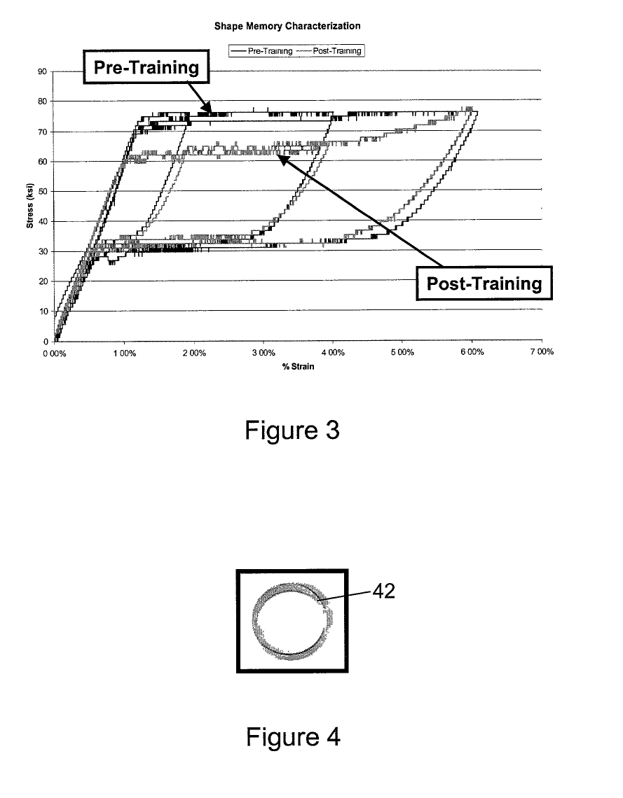

Nickel-titanium (NiTi) is a preferred super-elastic shape memory alloy. NiTi is a unique material that undergoes a stress-induced reversible martensitic phase transformation and exerts a nearly constant force over large recoverable strains when in the preferred helical spring configuration. A specific configuration of the present invention uses the NiTi super-elastic shape memory alloy primarily in bending mode. The characterization, conditioning, forming, and analysis work described below provides the basis of the composite integration for the seals and sealing systems. Extensive research was conducted on the training and conditioning required to provide a shape memory alloy having the desired properties for the intended hybrid seal applications. The shape memory alloy processing variables included shape-forming, heat-treating, and loading and cycling limits. Hybrid super-elastomeric seal applications required a relatively constant force with little or no degradation of the seal characteristics over time and over many cycles. Optimal heat treatment and processing cycles stabilized the properties of the shape memory alloy to obtain constant force and to eliminate creep. FIG. 3 shows the super-elastic shape memory alloy material tensile stress strain curves before and after optimal processing.

It has been determined that in producing NiTi super-elastic shape memory alloy material, heat treatment is an important step for obtaining a near constant force in the seals for sealing applications. Since the bending mode is the loading mode of the super-elastic shape memory alloy, 3-point bend tests were performed to characterize and determine the optimal heat treatment. Specifically, FIG. 3 is a graph of stress versus strain showing the tensile stress strain curve for a shape memory alloy helical spring element material as formed, and the tensile stress strain curve of the same material after it had received optimal processing.

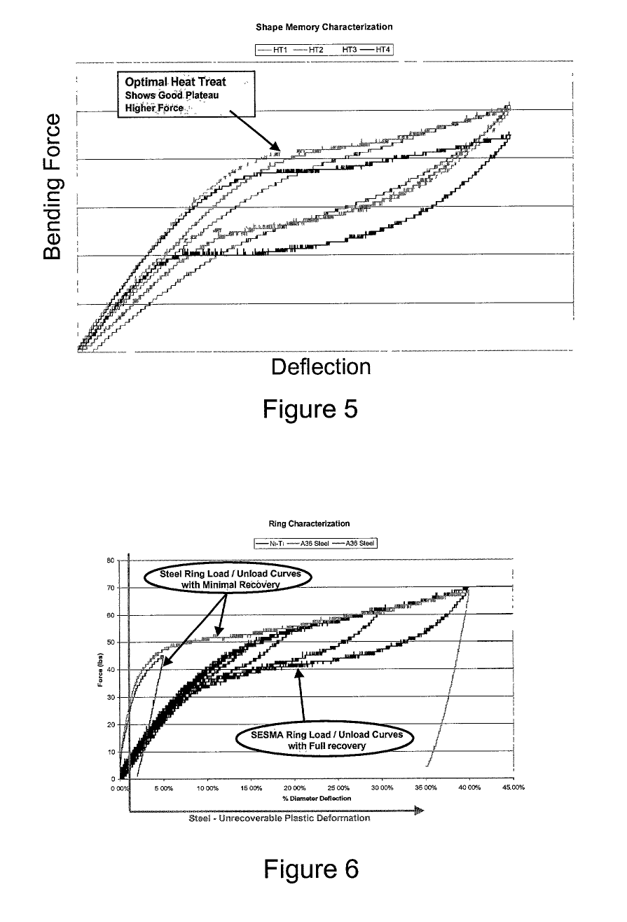

Additionally, the complex behavior of the circular ring cross sectional area of the super-elastic shape memory alloy spring core of the NiTi super-elastic shape memory alloy material was determined. FIG. 4 shows a manufactured super-elastic shape memory alloy ring 42 used in performing a heat treatment bending test. Ring 42 consists of one coil of a helical ribbon spring. A bending test was performed with ring 42. FIG. 5 is a graph of bending force versus deflection showing the stress strain curves based on bend tests of several super-elastic shape memory alloy helical ring elements 42 of FIG. 4, each ring having been subjected to a different heat treatment. Test results, shown in FIG. 5, indicated very good super-elastic characteristics for the optimal heat treated ring when used in sealing applications. For comparison, FIG. 6 shows results of a steel ring having the same geometry as ring 42. The super-elastic shape memory alloy ring 42 demonstrated at least an order of magnitude better recoverable strain capacity than the steel ring. In sealing applications, this characteristic of the super-elastic shape memory alloy ring 42 is important in providing hybrid super-elastic seals 20 capable of consistently maintaining sealing force and providing the flexibility necessary in good seal designs.

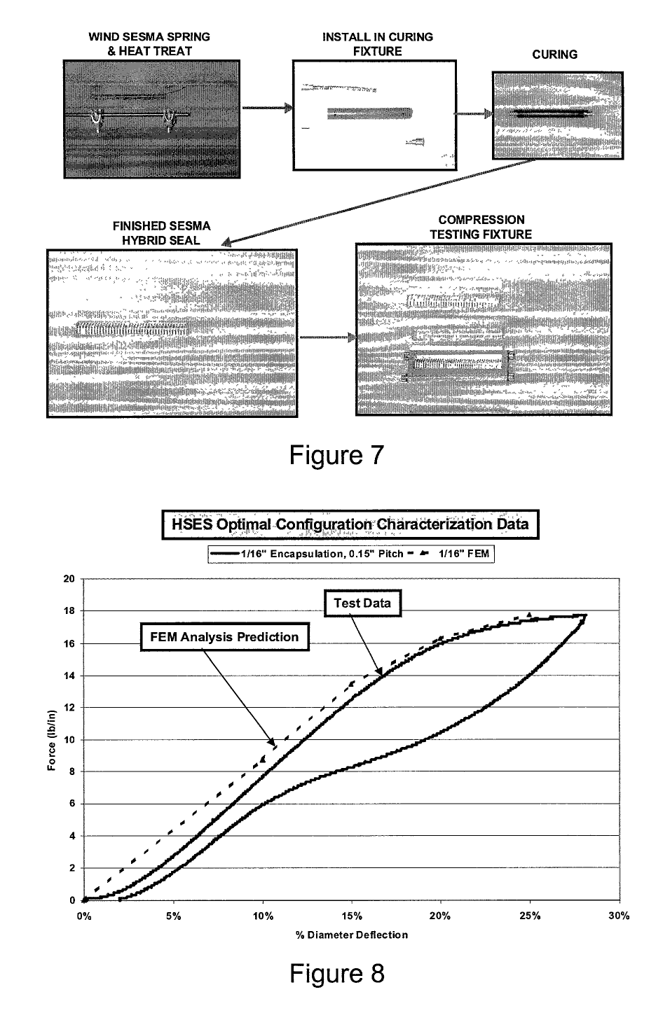

Once obtained, the super-elastic shape memory alloy may be embedded into or surrounded by an elastomeric material according to methods known to those skilled in the art. FIG. 7 shows one process for forming a super-elastic shape memory alloy helical spring element, producing a hybrid super-elastomeric seal, and subjecting it to compression testing. Various super-elastic shape memory alloy spring geometries were built and casted into several different durometers of elastomer using the process described in FIG. 7. Specifically, the super-elastic shape memory alloy spring was wound to the desired geometry and subjected to heat treatment. The resulting spring was then installed in a curing fixture and the elastomeric material poured into the fixture to embed the spring in the elastomer. Alternatively, the super-elastic shape memory alloy hybrid seal may be assembled separately from elastomer casting, wherein the super-elastic shape memory alloy helical spring element is placed, for example, within (e.g., in the groove of) a preformed elastomer. If desired, the spring element may be sealed with additional elastomer. The finished super-elastic shape memory alloy hybrid seal was placed in a compression testing fixture and subjected to compression testing.

The development and integration of a super-elastic shape memory nickel-titanium alloy spring element 32 with a silicone elastomer 34 was accomplished through research, analysis, design and fabrication, and testing of a hybrid super-elastic O-ring seal. The hybrid super-elastomeric seals 20 of the present invention may be used to replace current state-of-the-art elastomeric and metallic high performance seals and seal systems. The hybrid super-elastomeric seals 20 of the present invention also preferably allow for constant sealing forces over a large seal strain by eliminating compression set problems, and also by compensating for large distortions in sealing surfaces. These seals also preferably provide for reduction in damage to hardware from seal failures, decrease the forces required for elastomer sealing, reduce the need for tight hardware tolerances, and minimize the cost of sealing surface manufacturing for all applications. In addition, the hybrid super-elastomeric seals 20 of the present invention have significant utility in commercial industries (i.e., automotive, chemical and aerospace industries) for providing static, dynamic and pressurized sealing systems.

Research, design analysis and testing confirmed that the hybrid super-elastomeric seals 20 of the present invention provided high performance, long life and compression set failure resistant sealing. Through the above described testing, the hybrid super-elastomeric seal performance variables and their interactions in complex hyperelastic loading schemes were determined. Hypotheses were then deduced to optimize the hybrid super-elastomeric seals to eliminate as many of the variables as possible. Finite element modeling was used to help understand the test data and to further simplify the optimization of the hybrid super-elastomeric seals 20 of the present invention.

Application testing was performed on an Instron testing system for requirement compliance and feasibility for the optimal specimen configuration. The tests provided a clear picture of the advantages of the hybrid super-elastomeric seal technology. Using the Instron compression tester, optimized hybrid super-elastomeric seal test specimen were compressed to about 25% of the specimen diameter. The compressed seals were then unloaded at 0.05 in/min cycle time. The force and deflection data was recorded. FIG. 8 is a graph of force versus percent diameter deflection of the optimized hybrid super-elastic seal test specimen 20 of the present invention. The finite element module prediction is also shown in the same graph for comparison.

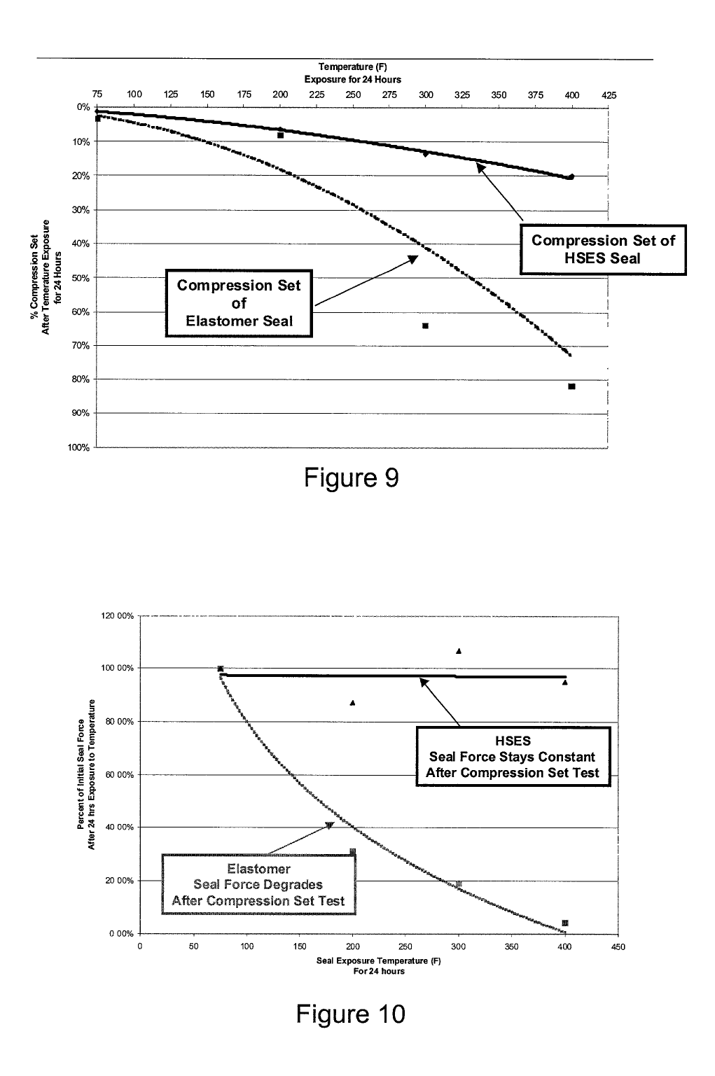

The Instron compression characterization test was then repeated, but with the compression load held for 24 hours at temperatures from 20° C. to 200° C. The permanent reduction in the diameter of the hybrid super-elastomeric seals 20 were recorded and plotted as compression set failure (or percent of deflection that did not return). FIG. 9 is a graph of percent compression set failure of optimized hybrid super-elastic seal 20 test specimen of the present invention compared with the percent compression set failure of similar elastomeric seals without the embedded super-elastic alloy spring. This data show that the hybrid super-elastomeric seals exhibited 2 to 5 times less compression set failure than the elastomeric seals without the embedded super-elastic alloy spring. FIG. 10 is a graph of percent sealing force over time of optimized hybrid super-elastic seal test specimen of the present invention compared with the percent sealing force of similar elastomeric seals without the embedded super-elastic alloy spring. Even though some compression set failure has occurred, FIG. 10 shows that the sealing force of the hybrid super-elastomeric seals 20 stayed constant. It is therefore seen that the hybrid super-elastomeric seals 20 substantially eliminated compression set failure, and related problems.

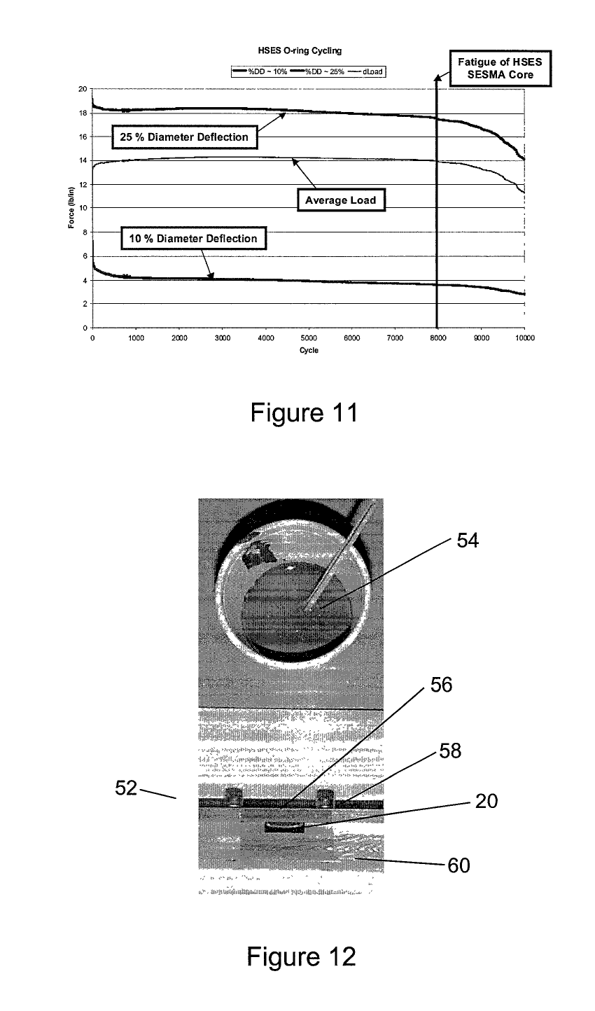

The Instron compression characterization test was then repeated on the optimized hybrid super-elastic seals 20, with repeating compression sets of 10% to 25% deflection for 10,000 cycles, as shown in FIG. 11. It is seen that the seal 20 survived the cycling, but demonstrated some alloy fatigue failures in the helical spring element 32 at about 8000 cycles. It is postulated that the fatigue of super-elastic shape memory alloy element 32 can be substantially improved by several orders of magnitude with heat treatment and conditioning.

A fixture 52 was built to hold a surviving segment of the hybrid super-elastomeric seal specimen 20 that was cycled 10,000 times in a compressed state at 25% of its diameter to test ambient pressure leakage with water. FIG. 12 shows the leakage test fixture set up 52. Colored water 54 was used for ease of determining leakage. To prevent leakage out of the sides of the fixture, the ends 58, 60 were capped with silicone sealant 56. No evidence of fluid leakage through the cycled hybrid super-elastomeric seal 20 was seen even after 72 hours.

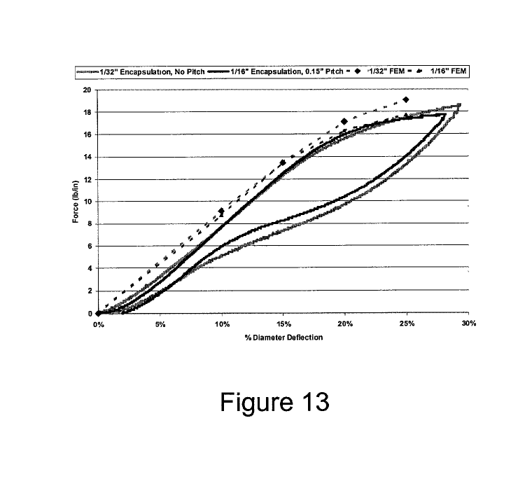

Using the design principles and the test/analysis results, two hybrid super-elastomeric seal geometric configurations were designed, manufactured and tested for verification. FIG. 13 is a graph showing force versus percent diameter deflection for similar sealing forces, of two different hybrid super-elastic seal configurations of the present invention. The comparison of the two configurations in characterization tests confirms that the modeling parameters worked. It was possible to obtain similar sealing forces from two different hybrid super-elastomeric seal configurations. The hybrid super-elastomeric seal using the shape memory alloy with the smallest hysteresis represents the optimal design. Nevertheless, the alternative hybrid super-elastic seal design is still superior to prior art elastomeric seals that do not contain a shape memory alloy insert.

In summary, FIGS. 9 and 10 show the outstanding performance of the optimized hybrid super-elastomeric seals 20. The figures indicate that compression set failure of the hybrid super-elastomeric seals of the present invention may be very low. More importantly, they demonstrate that the seal force may stay constant, eliminating the problems associated with compression set failure. Thus, when a super-elastic shape memory alloy spring is hybridized with a silicone elastomer chosen for sealing characteristics and environmental survivability, the outcome is a high performance hybrid super-elastomeric seal 20. These hybrid super-elastomeric seals can be compression set failure resistant and able to maintain constant sealing force, for example in a hatch system 22, despite large strains.

It is, therefore, seen that the hybrid super-elastomeric seals of the present invention represent a solution to sealing problems and provides substantial improvement for most sealing applications. The present invention provides the design, production, and integration of an optimized super-elastic shape memory alloy core element 32 with a common elastomer to create novel hybrid super-elastomeric seals. The present invention also relates to finite element models capable of simulating the hybrid super-elastomeric seal performance and testing hybrid super-elastomeric seal specimen for comparison.

The foregoing exemplary descriptions and the illustrative preferred embodiments of the present invention have been explained in the drawings and described in detail, with varying modifications and alternative embodiments being taught. While the invention has been so shown, described and illustrated, it should be understood by those skilled in the art that equivalent changes in form and detail may be made therein without departing from the true spirit and scope of the invention, and that the scope of the present invention is to be limited only to the claims except as precluded by the prior art. Moreover, the invention as disclosed herein, may be suitably practiced in the absence of the specific elements that are disclosed herein.

I claim:

1. A hybrid super-elastomeric seal comprising a body of elastomeric material and a super-elastic shape memory alloy embedded within said body of elastomeric material.

2. The hybrid super-elastomeric seal of claim 1, wherein said elastomeric material is compressible and tends to resume its original size and shape.

3. The hybrid super-elastomeric seal of claim 2, wherein said elastomeric material is a natural material or a polymer.

4. The hybrid super-elastomeric seal of claim 3, wherein said natural material is rubber.

5. The hybrid super-elastomeric seal of claim 3, wherein said polymer is selected from the group consisting of butadiene, fluoro-silicone, silicone, neoprene, nitrile and Viton.

6. The hybrid super-elastomeric seal of claim 5, wherein said polymer is silicone.

7. The hybrid super-elastomeric seal of claim 1, wherein said super-elastic shape memory alloy is a nickel-titanium alloy.

8. The hybrid super-elastomeric seal of claim 1, wherein said super-elastic shape memory alloy is in a shape that provides tensility, compression or bending.

9. The hybrid super-elastomeric seal of claim 8, wherein said shape is a spring element.

10. The hybrid super-elastomeric seal of claim 9, wherein said spring element is in a form selected from the group consisting of helical and c-section.

11. The hybrid super-elastomeric seal of claim 8, wherein said super-elastic shape memory alloy is in a form selected from the group consisting of wire, ribbon, sheet and rod.

12. The hybrid super-elastomeric seal of claim 1, wherein said hybrid super-elastomeric seal is in the form selected from an O-ring and gasket.

13. The hybrid super-elastomeric seal of claim 1, wherein said super-elastic shape memory alloy has the property of reversible martensitic phase transformation.

14. The hybrid super-elastomeric seal of claim 13, wherein said property of reversible martensitic phase transformation utilizes stress cycling.

15. The hybrid super-elastomeric seal of claim 1, wherein said seal reduces compression set failure.

16. The hybrid super-elastomeric seal of claim 1, wherein said seal provides improved recoverable strain capacity for repeatedly maintaining sealing force.

17. The hybrid super-elastomeric seal of claim 1, wherein said seal provides constant seal force after compression sets.

18. A seal system comprising a frame, a receiving frame and a hybrid super-elastomeric seal.

19. The seal system of claim 18, wherein said seal system is scalable to any size.

20. The seal system of claim 19, wherein said seal system comprise static seals.

21. The seal system of claim 20, wherein said static seals is selected from the group consisting of hatches and doors.

22. The seal system of claim 21, wherein said seal system is a hatch system.

23. The seal system of claim 22 comprising a hatch door, a hatch door receiving frame and a hybrid super-elastomeric seal.

24. The seal system of claim 23, wherein said seal is carried continuously around the entire circumference of the hatch door to seal the hatch system.

25. The seal system of claim 23, wherein said seal is carried continuously around the entire circumference of the hatch door receiving frame to seal the hatch system.

26. The seal system of claim 23, wherein said seal is carried continuously around the entire circumference of both the hatch door and the hatch door receiving frame to seal the hatch system.

27. The seal system of claiml9, wherein said seal system comprise dynamic seals.

28. The seal system of claim 27, wherein said dynamic seals is selected from the group consisting of actuators, hydraulics, pneumatics and valves.

29. The seal system of claim 18, wherein said seal further comprises a body of elastomeric material and a super-elastic shape memory alloy embedded within said body of elastomeric material.

30. The seal system of claim 29, wherein said elastomeric material is compressible and tends to resume its original size and shape.

31. The seal system of claim 30, wherein said elastomeric material is a natural material or a polymer.

32. The seal system of claim 31, wherein said natural material is rubber.

33. The seal system of claim 31, wherein said polymer is selected from the group consisting of butadiene, fluoro-silicone, silicone, neoprene, nitrile and Viton.

34. The seal system of claim 31, wherein said polymer is silicone.

35. The seal system of claim 29, wherein said super-elastic shape memory alloy is a nickel-titanium alloy.

36. The seal system of claim 29, wherein said super-elastic shape memory alloy is in a shape that provides tensile, compression, torsion or bending.

37. The seal system of claim 36, wherein said shape is a spring element.

38. The seal system of claim 37, wherein said spring element is in a form selected from the group consisting of helical and c-section.

39. The seal system of claim 36, wherein said super-elastic shape memory alloy is in a form selected from the group consisting of wire, ribbon, sheet and rod.

40. The seal system of claim 18, wherein said hybrid super-elastomeric seal is in the form selected from an O-ring and gasket.

41. The seal system of claim 29, wherein said super-elastic shape memory alloy has the property of reversible martensitic phase transformation.

42. The seal system of claim 41, wherein said property of reversible martensitic phase transformation utilizes stress cycling.

43. The seal system of claim 29, wherein said seal reduces compression set failure.

44. The seal system of claim 29, wherein said seal provides improved recoverable strain capacity for repeatedly maintaining sealing force.

45. The seal system of claim 29, wherein said seal provides constant seal force after compression sets.

46. A method of manufacturing a hybrid super-elastomeric seal comprising the steps of:
forming the super-elastic shape memory alloy to a desired geometry;
subjecting the super-elastic shape memory alloy to heat treatment; and
embedding the super-elastic shape memory alloy spring element in an elastomer.

47. The method of claim 46, wherein said embedding step comprises the steps of:
installing the super-elastic shape memory alloy spring element in a curing fixture;
pouring elastomeric material into said curing fixture, wherein said spring is embedded in the elastomer; and
allowing the elastomeric material to solidify to form said hybrid super-elastomeric seal.

48. The method of claim 46, wherein said embedding step comprises the steps of:
preforming the elastomer in a cast; and
assembling the hybrid super-elastomeric seal.

49. The method of claim 48, wherein said preforming step comprises forming an elastomer portion such that the shape memory alloy spring element will fit in the elastomer.

50. The method of claim 48, wherein said assembling step comprises the step of placing said shape memory alloy spring element in said elastomer.

51. The method of claim 50, further comprising the step of sealing said shape memory alloy spring element with additional elastomer.

52. The method of claim 46, wherein said elastomeric material is compressible and tends to resume its original size and shape.

53. The method of claim 46, wherein said elastomeric material is a natural material or a polymer.

54. The method of claim 53, wherein said natural material is rubber.

55. The method of claim 53, wherein said polymer is selected from the group consisting of butadiene, fluoro-silicone, silicone, neoprene, nitrile and Viton.

56. The method of claim 55, wherein said polymer is silicone.

57. The method of claim 46, wherein said super-elastic shape memory alloy is a nickeltitanium alloy.

58. The method of claim 46, wherein said super-elastic shape memory alloy is in a shape that provides tensile, compression or bending.

59. The method of claim 58, wherein said shape is a spring element.

60. The method of claim 59, wherein said spring element is in a form selected from the group consisting of helical and c-section.

61. The method of claim 58, wherein said super-elastic shape memory alloy is in a form selected from the group consisting of wire, ribbon, sheet and rod.

62. The method of claim 46, wherein said hybrid super-elastomeric seal is in the form selected from an O-ring and gasket.

63. The method of claim 46, wherein said super-elastic shape memory alloy has the property of reversible martensitic phase transformation.

64. The method of claim 46, wherein said property of reversible martensitic phase transformation utilizes stress cycling.

65. The method of claim 46, wherein said seal reduces compression set failure.

66. The method of claim 46, wherein said seal provides improved recoverable strain capacity for repeatedly maintaining sealing force.

67. The method of claim 46, wherein said seal provides constant seal force after compression sets.
